(19) United States
(12) Patent Application Publication
(10) Pub. No.: US 2010/0306084 A1
(43) Pub. Date: Dec. 2, 2010

(54) NEED-BASED ONLINE VIRTUAL REALITY ECOMMERCE SYSTEM

(76) Inventor: Yunus Ciptawilangga, Bandung West Java (ID)

Correspondence Address: Vern Maine & Associates, 547 AMHERST STREET, 3RD FLOOR, NASHUA, NH, 03063-4000, US

(21) Appl. No.: 12/839,782

(22) Filed: Jul. 20, 2010

Related U.S. Application Data
(63) Continuation-in-part of application No. 12/474,202, filed on May 28, 2009.
Application No. 12/474,202 is a continuation-in-part of application No. 12/474,206, filed on May 28, 2009.

(30) Foreign Application Priority Data
Jul. 27, 2009 (ID) C00200902897

(51) Int. Cl. G06Q 30/00; G06F 3/048

(52) U.S. Cl. 705/27; 715/765

(57) ABSTRACT

An online virtual reality ecommerce system imposes needs upon its avatars, thereby enhancing the simulation of reality, and providing need-based motivations for ecommerce in addition to enjoyment-based motivations. The virtual needs also cause avatars to be perceived as independent beings which can independently enjoy, desire, and suffer based on experiences and purchases within the virtual world. This causes users to emotionally bond with their avatars, and to feel compassion, empathy, and even friendship toward them. Users feel increased desires to spend time online with their avatars, and to purchase goods for their avatars as well as for themselves. Avatars can be fantasy avatars in a virtual fantasy world, and their needs can include special, fantasy items. Basic needs can include food, clothing, shelter, exercise, bathing, shaving, medicine, and haircuts. Entertainment can be needed to avoid boredom, and specific tools, equipment, fuel, and/or transportation can be needed for various activities.

### RELATED APPLICATIONS

This application is a continuation in part of U.S. application Ser. Nos. 12/474,202, filed May 28, 2009, and 12/474,206, filed on May 28, 2009. This application also claims the benefit of Indonesian patent application C00200902897, filed on Jul. 27, 2009, all of which are incorporated herein by reference in their entirety for all purposes.

### FIELD OF THE INVENTION

The invention relates to online e-commerce systems, and more particularly to online virtual reality ecommerce systems.

### BACKGROUND OF THE INVENTION

Online, internet accessible “virtual reality worlds” have become increasingly popular, as personal computers have grown in power and become widely affordable, and high-speed internet access has become commonplace. Online virtual reality worlds can provide to an internet user an illusion of exploring, interacting with, and generally existing in a computer-generated world that mimics the real world in many ways. Internet accessible virtual reality worlds are typically hosted by one or more internet servers, and can be accessed over the internet using almost any internet-capable device, such as a personal computer or a portable, hand-held internet-capable device.

Typically, a user interacts with a virtual reality world by controlling the actions of a virtually intelligent being, also known as an “avatar.” In many virtual reality worlds, avatars are able to mimic the actions of real people in many ways, such as by looking in different directions, moving to different locations, entering buildings, handling objects, and even interacting with other avatars. Interactions between avatars can include speaking, showing facial expressions, and using movements to display a range of feelings and emotions, for example by drooping over to indicate illness, shedding tears to show sadness, or jumping around to show joy or excitement. Generally, an avatar functions as an extension of its user, by going where the user directs, looking where the user wishes to look, and expressing emotions which reflect the emotions of the users. Note that some avatars appear to have male or female genders, while other avatars do not have obvious genders. For simplicity, neuter pronouns will be used herein to refer to avatars, regardless of their apparent gender.

Ecommerce is frequently included in online virtual reality worlds, whereby an avatar is able to view and/or listen to advertisements, view and/or handle items for sale, and complete purchase transactions for selected items. In many instances, virtual items such as virtual clothing or virtual homes can be purchased for use by an avatar within the virtual world.

Some online virtual reality worlds also enable avatars to examine and purchase a virtual representation of a real item, after which the corresponding real item is shipped in the real world to the controller of the avatar. This approach enables a consumer to enjoy a simulated “real-world” shopping experience without having to leave the comfort of home. Some virtual reality worlds even provide virtual retail locations, where an avatar controlled by a consumer can interact with an avatar controlled by a vendor salesman, thereby simulating an interaction between a customer and a retail salesperson in the real world. The two avatars can exchange information regarding products for sale, consider options, and complete a purchase transaction.

In general, it is the simulation of “real” life, or at least of an experience which “seems” real to a user, which motivates the user to spend time interacting with an online virtual reality world. Therefore, the more closely an online virtual reality world simulates the real world, the more “real” the virtual experience will seem to a user, and the more motivated the user will be to spend time and carry out activities in the virtual world. And of course, the more motivated a user is to spend time in a virtual world, the more likely the user will be to engage in e-commerce within the virtual world.

Typical online virtual reality worlds include a variety of features which are intended to enhance the realism of the virtual experience. As mentioned above, avatars are able to carry out many activities typical of real people, such as shopping, visiting a restaurant, working, playing, going to a movie, exploring a new location, and even buying or building a home and living in it. In many known virtual reality worlds, avatars are able to interact with each other as proxies of their users, and to communicate the emotions as well as the words of the users. However, these online virtual reality worlds still fall short of simulating a “real-life” experience, and in particular they fail to create an environment which motivates ecommerce to the degree that commerce is motivated in the real world.

What is needed, therefore, is an online virtual reality ecommerce system which is based on a virtual reality world having enhanced simulation features that cause the virtual reality world to closely simulate the real world, thereby increasing a user's motivating to spend time in the online virtual world and to engage in ecommerce within the online virtual world.

### SUMMARY OF THE INVENTION

The present invention is an online virtual reality ecommerce system based on a virtual reality world which imposes needs upon its avatars, thereby providing an enhanced simulation of the real world, and providing need-based motivations for ecommerce in addition to enjoyment-based motivations.

In real life, many of our actions are driven by needs, rather than simply desires for recreation, amusement, or other enjoyments. These needs provide strong motivations in the real world, and they also enhance our commitment, involvement, enjoyment, and pride of accomplishment in many of the things that we do. It could be said that life is need-driven more than it is enjoyment driven, since our needs must be met before we can turn our attention to recreation and other forms of enjoyment. Therefore, the virtual reality world of the present invention in which many actions and goals are motivated by needs provides a more realistic simulation of reality than virtual reality worlds in which actions and goals are motivated only be enjoyment.

Another benefit of imposing needs on avatars according to the present invention is that there is an enhanced tendency for the avatars to be perceived by their users as separately real entities. The capacity to suffer if needs are not met is basic and essential to the nature of real beings, including people, pets, and most other creatures. By imposing needs upon its avatars, the present invention increases the likelihood that users will relate to avatars as real beings, and will feel compassion, empathy, and even friendship toward them. Instead of being virtual marionettes or figurines, the avatars are perceived as virtual friends, children, and/or pets which can enjoy their relationship with their user, and can possibly suffer if their needs are not met. In virtual reality worlds of the present invention, users tend to emotionally bond with their avatars, which increases their desire to spend time online with their avatars, and to purchase goods for use by their avatars, as well as for use by themselves. As a result, ecommerce is enhanced.

In various embodiments, avatars of the present invention can suffer or even expire if they are not adequately fed, sheltered, and clothed. Avatars can become fat and unhealthy if they do not exercise, and they can become disheveled and otherwise take on undesirable appearances and even virtual odors if they do not bath, shave, have their hair cut, and such like.

In embodiments of the present invention, avatars require transportation if they wish to travel to various locations, and tools and/or protective clothing if they wish to undertake certain activities. Simulated vehicles require fuel, which must be purchased. Tools and clothing can wear out, and must be replaced. Avatars in fantasy environments must take on appropriate fantasy forms, and in some instances obtain appropriate clothing, tools, and other items so as to survive and function in the fantasy environment. Users are therefore motivated to engage in ecommerce so as to ensure that “their” avatars do not suffer, and so that the avatars will have whatever they need and will be able to do whatever they want or need to do.

In addition to basic survival needs, in embodiments of the present invention avatars and their users must invest realistic amounts of time and virtual money if they wish to engage in various desirable activities, thereby causing the activities to seem more real, and success in the activities to be more highly valued and enjoyed. For example, a visit to a distant location can require that the avatar purchase a ticket for a trip on a cruise ship. While in route, the avatar may shop in specialty stores on the ship, and may meet other avatars who share a similar interest in visiting the destination. When the destination is finally reached, the expense and anticipation of reaching the distant location serve to enhance the excitement and enjoyment upon finally arriving.

Of course, ecommerce requires a system of currency, and avatars according to the present invention require virtual currency so as to purchase the things that they need, such as food, clothing, housing, tools, transportation, and such like. In embodiments of the present invention, a user can purchase virtual currency for an avatar in exchange for real money. In some embodiments, an avatar can also “earn” virtual money by performing certain paid tasks within the virtual world. In addition, a unique feature of some embodiments of the present invention is that a user can “earn” money for his or her avatar by purchasing real goods within the virtual world. In some of these embodiments, the avatar receives an amount of virtual money in proportion to the amount of real money spent by the user. For example, the avatar might receive one virtual dollar for every real dollar spent by the user. In this way, the user can simultaneously meet his or her own needs and the needs of his or her avatar, simply by making purchases of real goods in the virtual world instead of in the real word.

Various embodiments of the present invention provide opportunities for an avatar to take on a fantasy form and to explore and experience a fantasy environment. In embodiments, an avatar is required to possess and use appropriate tools, and/or to take on an appropriate form, so as to exist and interact in the fantasy environment. For example, in some embodiments an avatar must either wear underwater equipment or must take on the form of an undersea creature so as to explore an undersea environment. Similarly, in certain embodiments an avatar must take on the form of a fairy so as to explore a fairy world where there is no firm ground to stand upon. In some embodiments, an avatar is required to purchase mining equipment so as to enter a mine and explore for gold or diamonds there, and in some of these embodiments the tools and other items wear out and must be repaired or replaced. Of course, according to the embodiment, many or all of these needs can only be met by expenditures of real and/or virtual funds, thereby further enhancing motivations to engage in ecommerce.

The present invention is an ecommerce system including media containing software which is operable on a server computer and accessible to a user through a computer network. The software is able to provide to the user a simulation of a virtual reality world which includes an avatar under control of the user, a virtual need imposed upon the avatar, whereby the virtual need must be satisfied so as to avoid an adverse effect upon the avatar, and at least one ecommerce opportunity which can be exercised within the virtual reality world so as to meet the virtual need.

In various embodiments, the avatar is a fantasy avatar, and the virtual reality world is a virtual fantasy world.

In some embodiments the virtual need is a need for virtual food. In some of these embodiments the adverse effect is one of hunger, low energy, and death by starvation. In other of these embodiments the ecommerce opportunity is a store within the virtual world where virtual food can be purchased for consumption by the avatar.

In certain embodiments the virtual need is a need for clothing, shelter, exercise, medicine, personal grooming, or entertainment. In other of these embodiments the adverse effect is discomfort, reduced health, death, poor physical fitness, excess virtual fatness, undesirable appearance, undesirable virtual odor, or unhappiness due to boredom.

In some embodiments the ecommerce opportunity is a virtual store where a virtual purchase can be made by the avatar so as to meet the virtual need. In various embodiments the ecommerce opportunity requires expenditure of virtual funds by the avatar. In some of these embodiments virtual funds are provided to the avatar according to an expenditure of real funds by the user in purchasing goods within the virtual reality world.

In certain embodiments the virtual need is a need to purchase transportation, and the adverse effect is an inability of the avatar to reach a desired destination within the virtual reality world.

In various embodiments the virtual need is a need for transfiguration of the avatar into a creature which is compatible with a specialized environment, and the adverse effect is one of denial of entry of the avatar into the specialized environment and diminished health of the avatar upon entering the specialized environment. And in some embodiments the virtual need is a need for equipment.

In various embodiments the virtual reality world provides an opportunity for the user to transact a purchase within the virtual reality world resulting in delivery of a real product to the user in the real world.

In some embodiments the virtual reality world provides an opportunity for the user to transact a purchase within the virtual reality world resulting in delivery of a real product to the user within the virtual reality world. And in other embodiments the virtual reality world includes a fantasy environment which can only be occupied by an avatar if the avatar includes attributes which are compatible with the fantasy environment.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is an illustration of an avatar of an embodiment of the present invention expressing laughter;

FIG. 1B is an illustration of an avatar of an embodiment of the present invention expressing surprise;

FIG. 1C is an illustration of an avatar of an embodiment of the present invention expressing sadness;

FIG. 2 is an illustration of an avatar of an embodiment of the present invention expressing joy while playing with a virtual toy;

FIG. 3 is an illustration of an avatar of an embodiment of the present invention expressing happiness while visiting an amusement park;

FIG. 4 is an illustration of customer avatars of an avatar of an embodiment of the present invention interacting with a sales clerk avatar in a virtual store while purchasing virtual goods for use by the avatars in the virtual world;

FIG. 5 is an illustration of a customer avatar of an embodiment of the present invention interacting with a sales clerk avatar in a virtual store while purchasing real goods for use by a controller of the customer avatar in the real world;

FIG. 6A is an illustration of an avatar of an embodiment of the present invention purchasing food items necessary for the survival of the avatar;

FIG. 6B is an illustration of an avatar of an embodiment of the present invention exercising so as to maintain the health and stamina of the avatar;

FIG. 7 is an illustration of an avatar of an embodiment of the present invention waiting to board a train for transportation to a distant location within the virtual world;

FIG. 8 is an illustration of an avatar of an embodiment of the present invention purchasing a ticket to board a boat so as to travel to a distant location within the virtual world;

FIG. 9 is an illustration of an avatar of an embodiment of the present invention shopping in a store while traveling on a boat to a distant location within the virtual world; and

FIG. 10 is an illustration of an avatar of an embodiment of the present invention purchasing tools required to perform a task within the virtual world.

### DETAILED DESCRIPTION

The present invention is an online virtual reality ecommerce system which enhances the tendency of users to spend time and money within a virtual reality environment by enhancing the realism of the virtual reality experience, and by enhancing a tendency of users to think of their avatars as real, independent beings, thereby increasing the motivation of users to emotionally bond with their avatars, spend time online with their avatars, and purchase goods for use by their avatars, as well as for themselves. The present invention enhances its realism and the appeal of its avatars by imposing virtual needs upon the avatars, similar to the needs of real beings in the real world. If these needs are not met, the avatars suffer, and in some embodiments they can even expire.

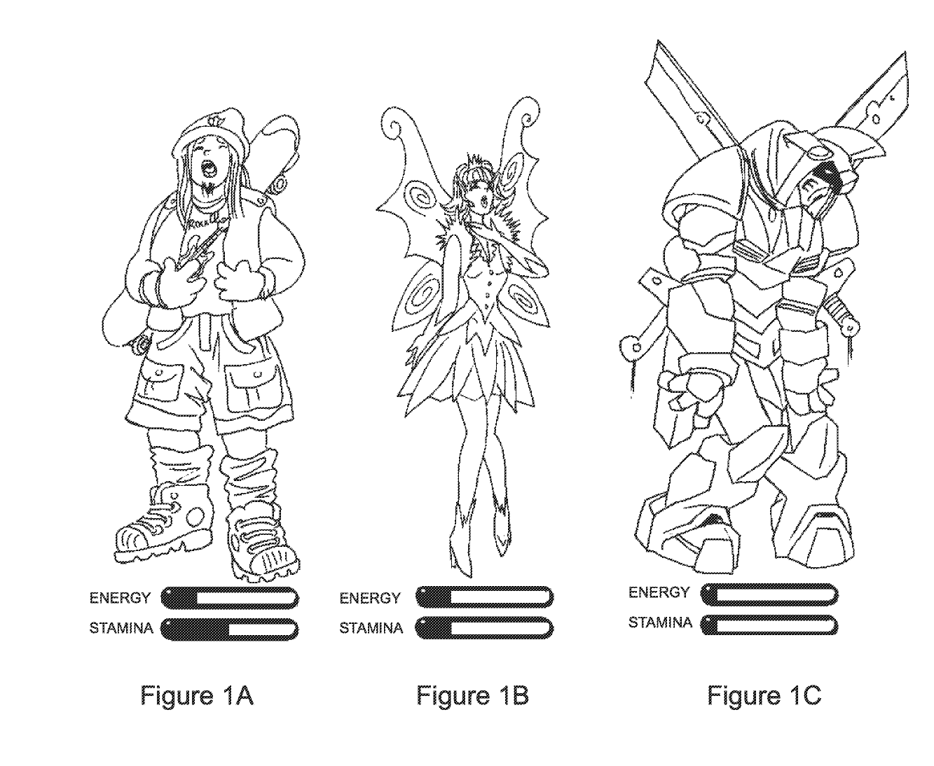

With reference to FIGS. 1A through 1C, in various embodiments avatars of the present invention can express a variety of emotions, such as laughter (FIG. 1A), surprise (FIG. 1B), and sadness (FIG. 1C). This ability to outwardly express emotions is not entirely unique to the present invention. However, typical avatars of the prior art lack the ability to be in want, to be hurt, or to suffer. Without these qualities, it is impossible for avatars to be perceived as having true emotions of their own. Instead, they are perceived only as proxies or puppets, which are under the control of their users and express only emotions which belong to their users, not to the avatars themselves. The realism of such “need-free” virtual reality worlds is also limited, since a virtual reality world in which actions and goals are motivated only by entertainment and enjoyment can never seem “real” to a user, who knows that in the real world most actions and goals are driven, or at least partly motivated, by needs as well as by enjoyments.

In the present invention, needs are imposed on the avatars, causing them to suffer, or at least to lose capabilities or be denied experiences, if their needs are not met. For example, in FIGS. 1A through 1C, indications of energy and stamina are provided for each avatar. In various embodiments, if an avatar does not receive basic needs such as food, rest, exercise, and medicine, the energy and stamina will decline, thereby depriving the avatar of happiness, and of the ability to do certain things which require energy and/or stamina. In some embodiments, prolonged depravation of needs can even cause the avatar to expire.

Imposing needs on avatars in the present invention has two important consequences. First, to the extent that a user perceives an avatar as a projection of the user into the virtual world, the user finds the experience much more compelling and “true to life.” Users feel an enhanced sense of commitment, involvement, enjoyment, and pride of accomplishment in many of the things that they do.

Second, in many instances the user begins to view the avatar as a separate being having needs, wants, and desires of its own. In such cases, the user in some sense begins to view the avatar as a virtual pet, child, or friend who depends upon the compassion and care of the user for his or her (or its) survival. Of course, this perception significantly increases the enjoyment and involvement of the user in the virtual experience, and strongly enhances the user's motivation to spend time in the virtual world and to engage in whatever experiences are available there—including ecommerce.

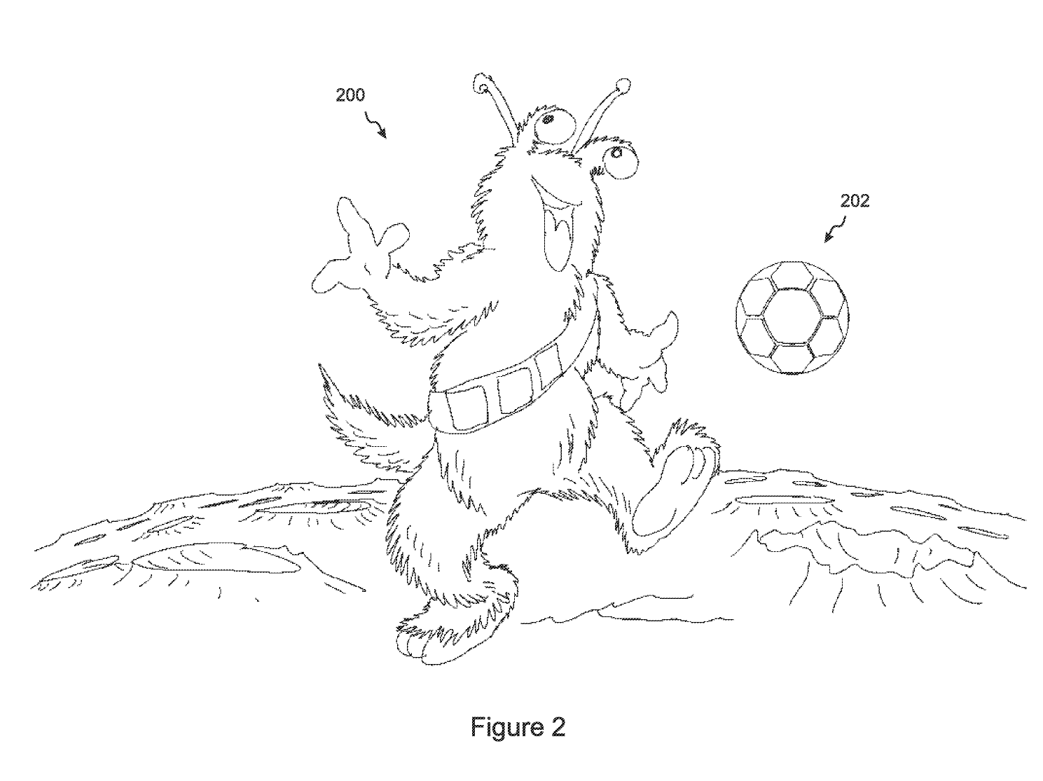

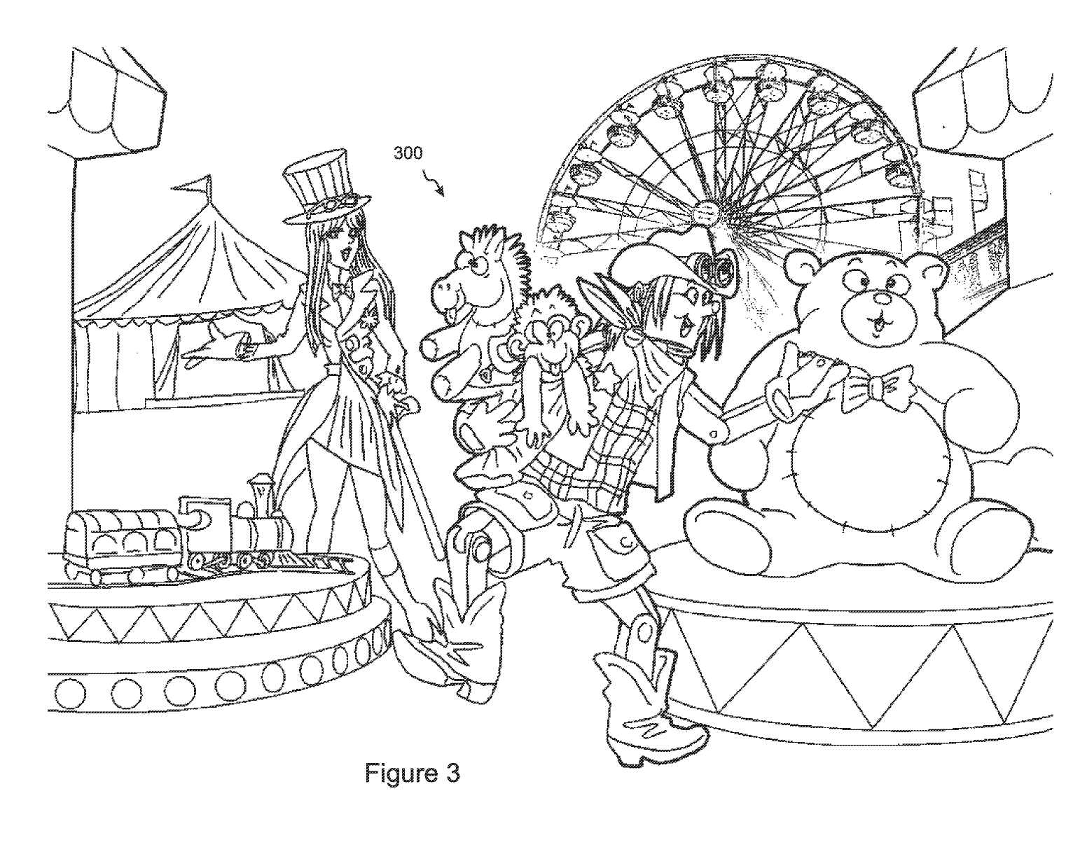

FIG. 2 illustrates an avatar 200 expressing obvious joy while playing with a ball 202. In embodiments of the present invention, the user (or the avatar) must purchase the ball 202 before this joyful play can be experienced by the avatar 200. Similarly, the avatar 300 in FIG. 3 must purchase an admittance ticket before the avatar 300 can enter and enjoy a virtual amusement park. While it might be unlikely that a user will directly experience joy due to an avatar bouncing a virtual ball or visiting a virtual amusement part in a virtual world, a user who perceives his or her avatar as being an independent being with its own emotions will rejoice in seeing the avatar experience joy from these activities, much in the same way that parents enjoy watching a pet or small child at play.

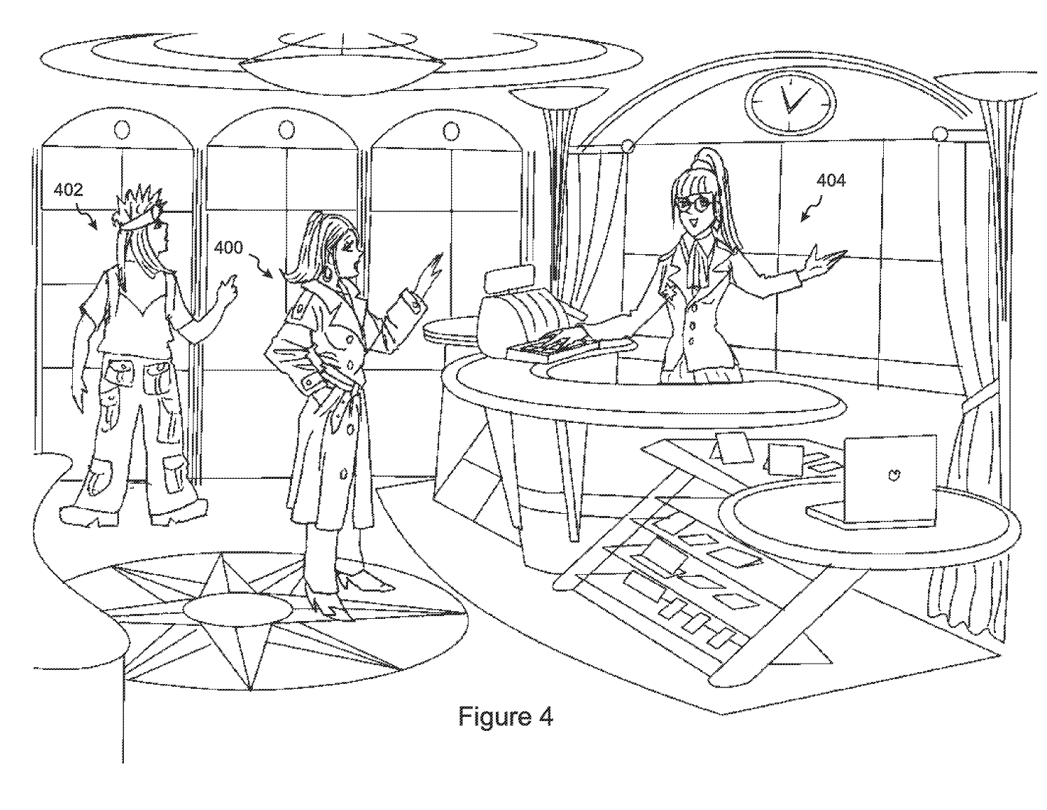

With reference to FIG. 4, in embodiments of the present invention avatars 400, 402 can shop for goods, such as food, clothing or cosmetics, which are to be used by the avatar 400, 402. In some cases, a virtual sales clerk 404 interacts with virtual customers 400, 402 so as to explain and demonstrate the products.

To the extent that a user perceives avatars as having “real” feelings, the user will be more strongly motivated to spend money to purchase products for the use and enjoyment of the avatars. In various embodiments, items for avatars can be purchased using currency from the real world, or virtual currency maintained in the virtual world. In the latter case, in various embodiments, real money can be exchanged for virtual money, an avatar can earn virtual money by performing paid tasks such as working in a virtual store (for example, the clerk 404 in FIG. 4), and/or virtual money can be awarded to an avatar in proportion to real money spent by the user within the virtual environment purchasing real goods for use in the real world.

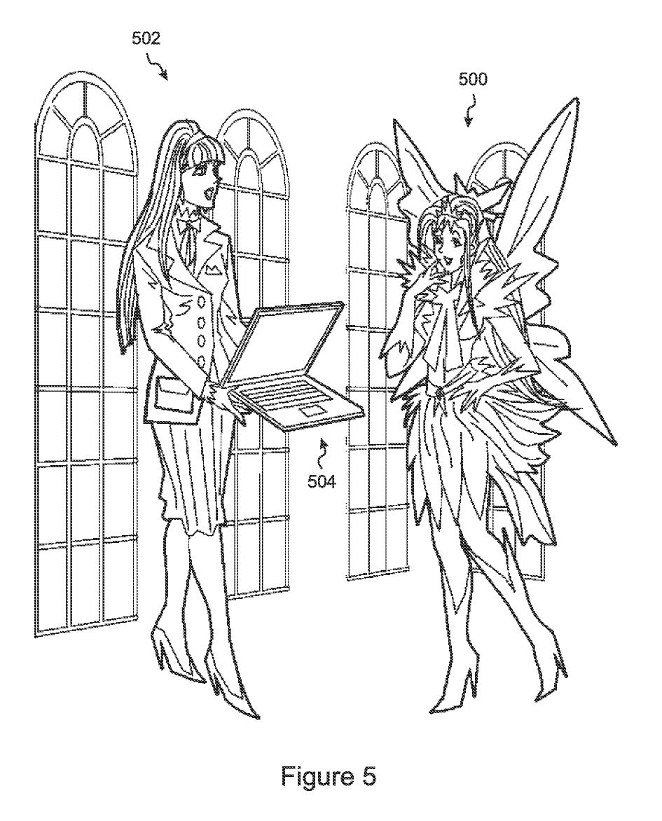

FIG. 5 illustrates an example from an embodiment in which an avatar 500 is shopping for real goods in a virtual store. In this example, a virtual clerk 502 is explaining the features of a laptop computer 504 to a customer avatar 500, in a manner similar to FIG. 4. However, in this example the virtual computer 504 is a virtual representation of a real computer in the real world, and if the transaction is completed, payment will be made using real money, and the corresponding real computer will be shipped to the user of the avatar 500 in the real world. In similar embodiments, virtual money can be spent to purchase real world goods, and vice versa. In some embodiments, a user can purchase a real service for delivery to the user within the virtual world, such as a horoscope, a lecture, or a presentation of a movie.

In some embodiments, spending of money by a user on real goods is rewarded by granting virtual money to the user's avatar. For example, in FIG. 5, if the avatar 500 purchases the computer 504, and the user pays $1500 in real currency, the corresponding real computer will be shipped to the user of the avatar 500, and the avatar 500 will receive 1500 virtual dollars to be spent on items for consumption within the virtual world. By making ecommerce purchases in this way, the user can satisfy his or her own wants and/or needs in the real world, while at the same time providing virtual funds for satisfying the virtual needs of his or her avatar 500 in the virtual world. Of course, in various embodiments the virtual currency is not necessarily denoted in dollars, and the exchange rate between real and virtual currencies is not necessarily 1:1.

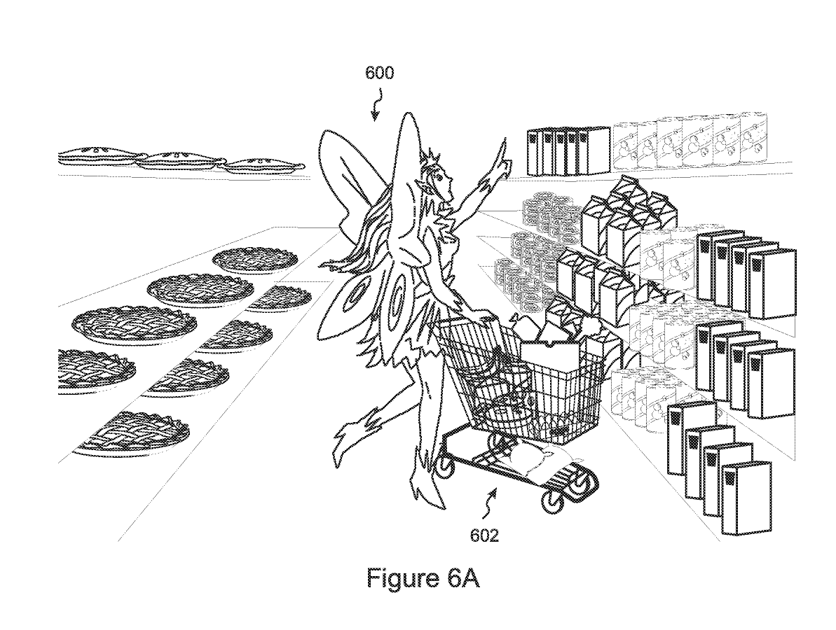

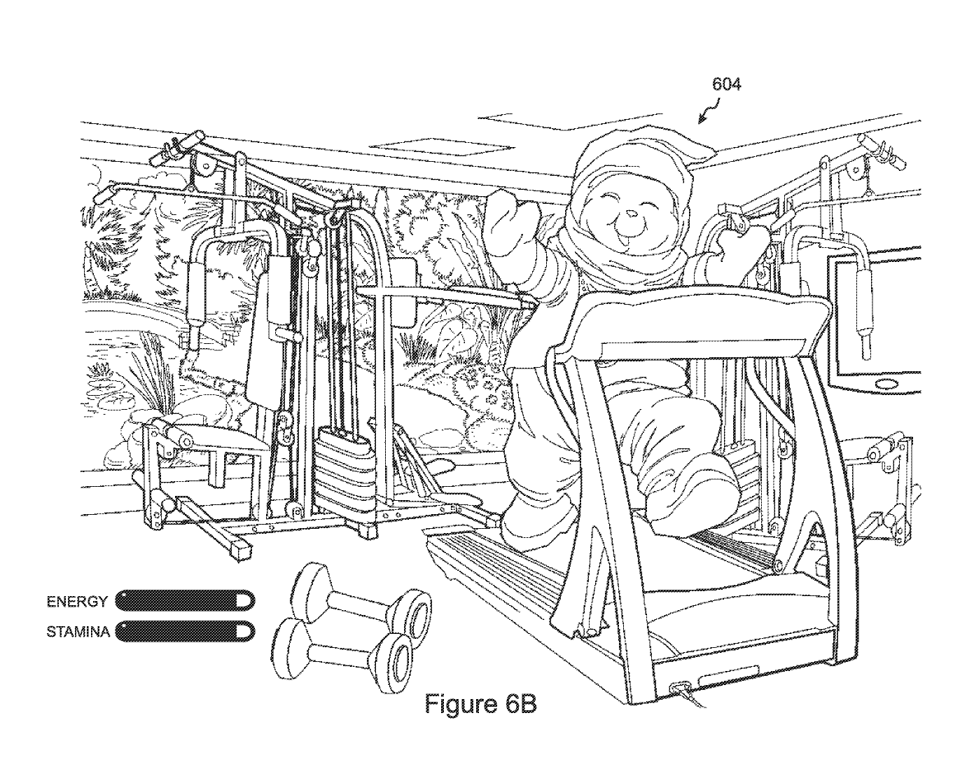

FIG. 6A illustrates an avatar in an embodiment of the present invention purchasing virtual food in a virtual grocery market for consumption by the avatar. Just as in real life, it may not be economically wise or even possible for an avatar to meet all of its food requirements be eating at restaurants, and so shopping and cooking can become a part of daily avatar life. As in the real world, in some embodiments of the present invention selecting and cooking food can become a source of enjoyment, as well as a means to satisfy a basic need. In general, many activities in embodiments of the present invention combine enjoyment with meeting basic needs, as they do in real life. The realism of the virtual experience is thereby significantly enhanced. FIG. 6B provides another example of an avatar 604 meeting a basic need, in this case by exercising at a gym so as to increase energy, stamina, and overall health. The improved health of the avatar 604 will enable it to participate in hiking and other activities which would not be otherwise possible. In some embodiments, avatars can combine enjoyment with exercise needs by participating in sports.

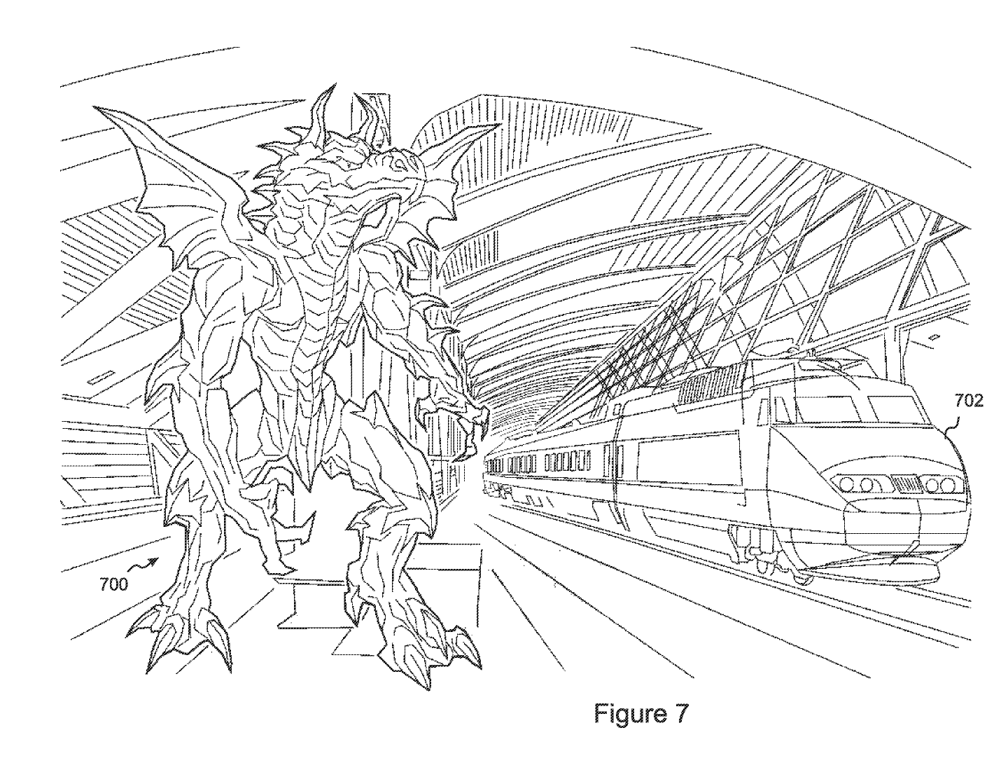

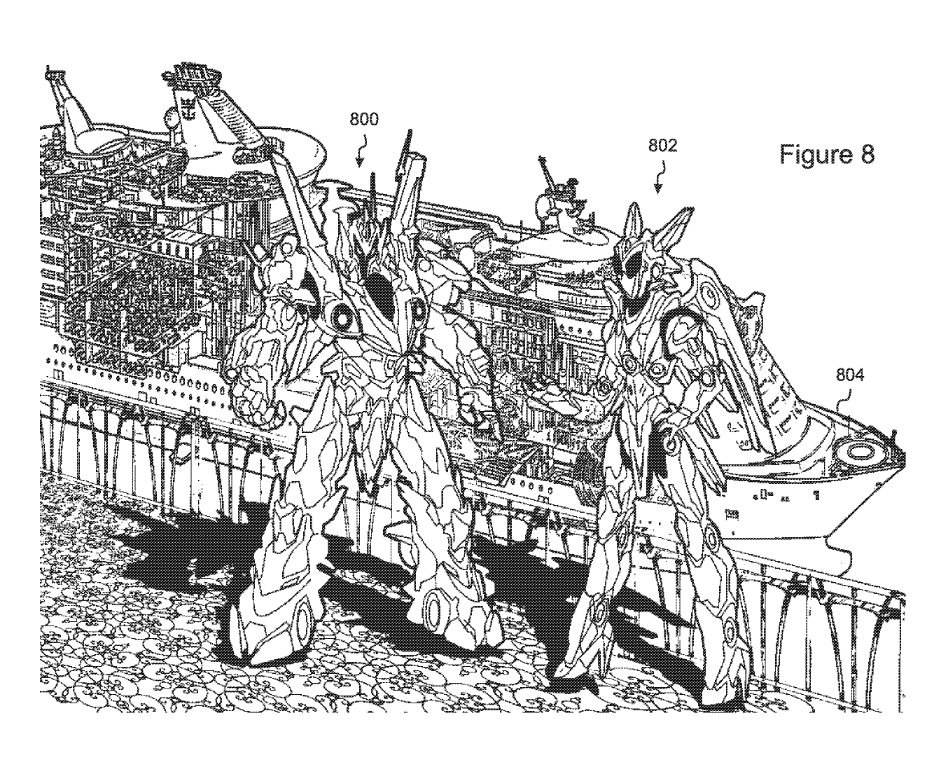

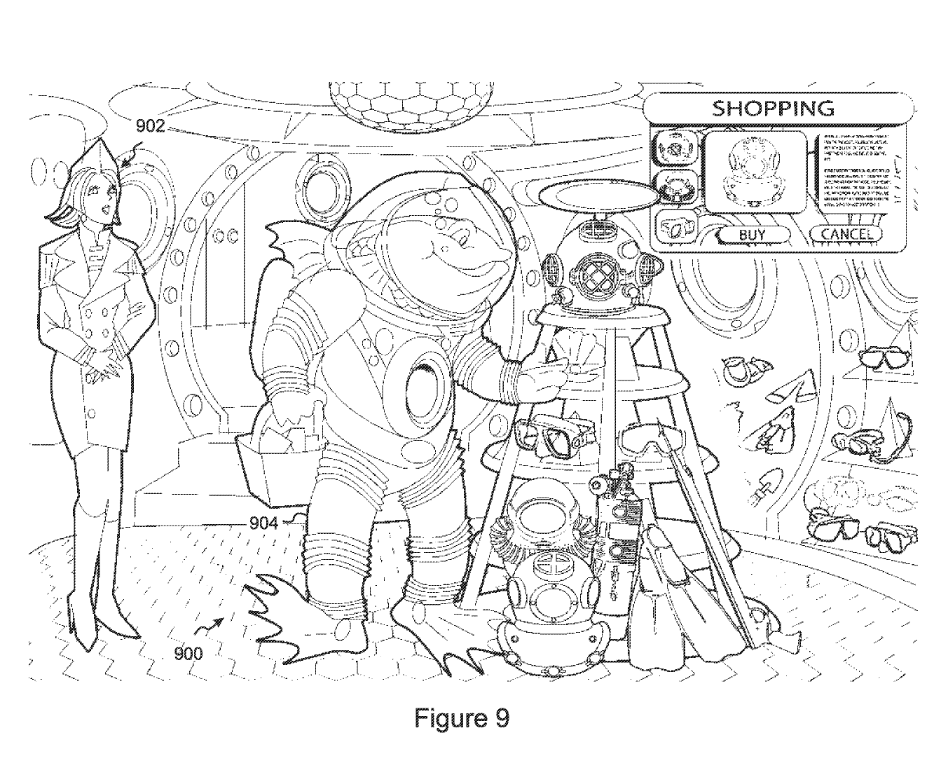

In various embodiments of the present invention, transportation is a virtual need which must be met so as to enable an avatar to travel to a remote location. FIG. 7 illustrates a fantasy avatar 700 which has purchased a train ticket, and is about to board a train 702. Similarly, FIG. 8 illustrates a fantasy avatar 800 negotiating with a sales avatar 802 to purchase a ticket for travel on a cruise ship 804. By requiring that an avatar expend time and virtual money so as to travel to a distant location, embodiments of the present invention ensure that when the destination is finally reached, the expense and anticipation of reaching the destination will serve to enhance the excitement and enjoyment of the avatar and its user upon finally arriving. In addition, opportunities for experiences and ecommerce can be provided during transportation. For example, FIG. 9 illustrates an aquatic avatar 900 purchasing various items from a sales person 902 while traveling on the cruise ship 804 of FIG. 8. Since the avatar 900 is a sea creature, it has already purchased and is wearing a special water suit 904 so as to be able to exist in the air environment of the ship 804. If the avatar 900 attempted to exist on the ship without the water suit 904, it would suffer and possibly die.

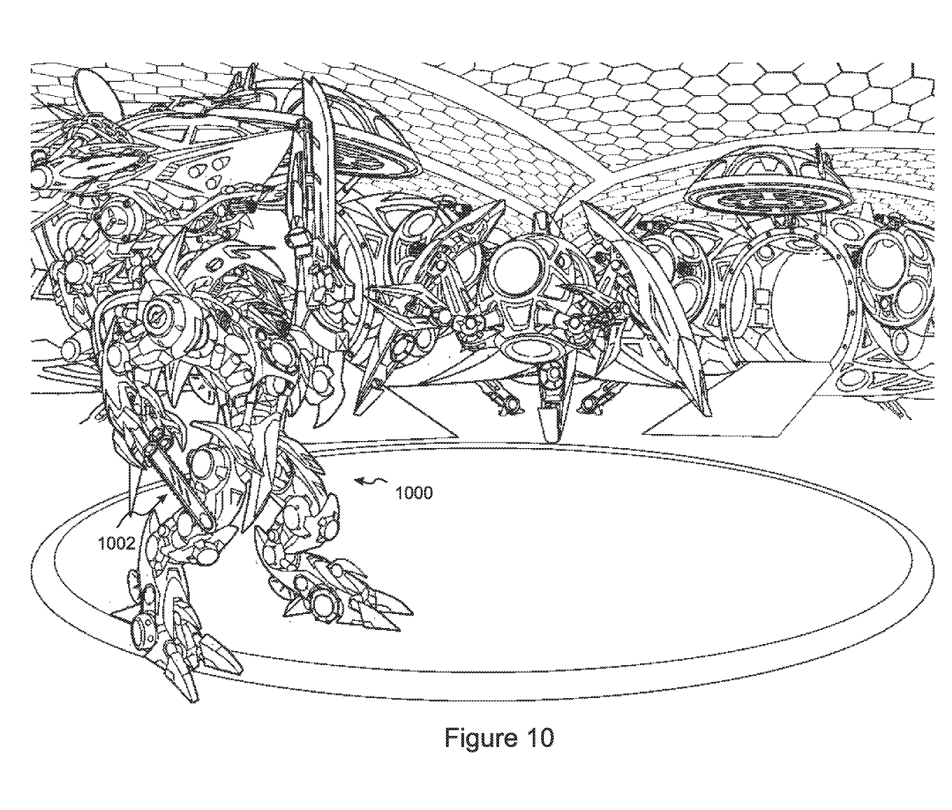

In various embodiments of the present invention tools and other special equipment are required so as to engage in certain activities. One example is the water suit 904 of FIG. 9. Another example is illustrated in FIG. 10, wherein a fantasy avatar 1000 has acquired a special “chain saw” appendage 1002 in preparation for battling another fantasy avatar in a virtual arena.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An ecommerce system comprising media containing software which is operable on a server computer and accessible to a user through a computer network, the software being able to provide to the user a simulation of a virtual reality world, the virtual reality world including:
an avatar under control of the user;
a virtual need imposed upon the avatar, whereby the virtual need must be satisfied so as to avoid an adverse effect upon the avatar, and
at least one ecommerce opportunity which can be exercised within the virtual reality world so as to meet the virtual need.

2. The ecommerce system of claim 1, wherein the avatar is a fantasy avatar, and the virtual reality world is a virtual fantasy world.

3. The ecommerce system of claim 1, wherein the virtual need is a need for virtual food.

4. The ecommerce system of claim 3, wherein the adverse effect is one of hunger, low energy, and death by starvation.

5. The ecommerce system of claim 3, wherein the ecommerce opportunity is a store within the virtual world where virtual food can be purchased for consumption by the avatar.

6. The ecommerce system of claim 1, wherein the virtual need is a need for one of:
clothing;
shelter;
exercise;
medicine;
personal grooming; and
entertainment.

7. The ecommerce system of claim 1, wherein the adverse effect is one of:
discomfort;
reduced health;
death;
poor physical fitness;
excess virtual fatness;
undesirable appearance;
undesirable virtual odor; and
unhappiness due to boredom.

8. The ecommerce system of claim 1, wherein the ecommerce opportunity is a virtual store where a virtual purchase can be made by the avatar so as to meet the virtual need.

9. The ecommerce system of claim 1, wherein the ecommerce opportunity requires expenditure of virtual funds by the avatar.

10. The ecommerce system of claim 9, wherein virtual funds are provided to the avatar according to an expenditure of real funds by the user in purchasing goods within the virtual reality world.

11. The ecommerce system of claim 1, wherein the virtual need is a need to purchase transportation, and the adverse effect is an inability of the avatar to reach a desired destination within the virtual reality world.

12. The ecommerce system of claim 1, wherein the virtual need is a need for transfiguration of the avatar into a creature which is compatible with a specialized environment, and the adverse effect is one of denial of entry of the avatar into the specialized environment and diminished health of the avatar upon entering the specialized environment.

13. The ecommerce system of claim 1, wherein the virtual need is a need for equipment.

14. The ecommerce system of claim 1, wherein the virtual reality world provides an opportunity for the user to transact a purchase within the virtual reality world resulting in delivery of a real product to the user in the real world.

15. The ecommerce system of claim 1, wherein the virtual reality world provides an opportunity for the user to transact a purchase within the virtual reality world resulting in delivery of a real product to the user within the virtual reality world.

16. The ecommerce system of claim 1, wherein the virtual reality world includes a fantasy environment which can only be occupied by an avatar if the avatar includes attributes which are compatible with the fantasy environment.
